(19) United States
(12) Patent Application Publication
(10) Pub. No.: US 2024/0354602 A1
(43) Pub. Date: Oct. 24, 2024

(54) COMPUTER-IMPLEMENTED METHOD AND DEVICE FOR MACHINE LEARNING OF FACTS, IN PARTICULAR FOR POPULATING A KNOWLEDGE BASE

(71) Applicant: Robert Bosch GmbH, Stuttgart (DE)

(72) Inventors: Lukas Lange, Pforzheim (DE); Heike Adel-Vu, Renningen (DE); Jannik Stroetgen, Karlsruhe (DE)

(21) Appl. No.: 18/632,709

(22) Filed: Apr. 11, 2024

(30) Foreign Application Priority Data
Apr. 20, 2023 (DE) 10 2023 203 660.6

(51) Int. Cl. G06N 5/022

(52) U.S. Cl. CPC G06N 5/022

(57) ABSTRACT

A device and a computer-implemented method for machine learning a fact in particular for populating a knowledge base. A character string is provided. A first set of embeddings of parts of the character string is determined. A second set of embeddings of parts of the character string is determined. For mutually corresponding embeddings from the sets, one of the variables for predicting the fact is determined in each case. The fact is determined, in particular in the knowledge base, depending on the variables.

### FIELD

The present invention relates to a computer-implemented method and to a device for machine learning of facts in particular for populating a knowledge base.

### BACKGROUND INFORMATION

For machine learning of facts, models that determine a fact depending on the embeddings of a character string are used. The models use word division methods for sentences in order to determine parts of character strings. The embeddings are determined for the individual parts. This can result in information being lost.

### SUMMARY

A computer-implemented method and the device for machine learning of a fact in particular for populating a knowledge base according to the present invention avoids this loss.

According to an example embodiment of the present invention, the method provides that a character string is provided, wherein a first set of embeddings of parts of the character string is determined, wherein a second set of embeddings of parts of the character string is determined, wherein the fact is determined, in particular in the knowledge base, depending on variables for predicting the fact, wherein, for mutually corresponding embeddings from the sets, one of the variables for predicting the fact is determined in each case. A variable represents a meta-embedding, which is determined from the parts of the character string whose embeddings correspond to one another.

This means that, depending on the embedding vocabulary, an embedding is assigned to a part of the character string that is created by a word division method, or several embeddings are assigned to the part. This achieves a granularity that corresponds to or is finer than that of the word division method. As a result, less information is lost if more than one embedding is created per part.

Preferably, according to an example embodiment of the present invention, the variables are determined independently of an embedding from the first set for which the second set does not comprise a corresponding embedding. This means that an embedding of the first set without a corresponding embedding in the second set is not taken into account.

Preferably, according to an example embodiment of the present invention, for an embedding from the first set for which the second set does not comprise a corresponding embedding, an embedding is provided independently of the character string, and one of the variables for predicting the fact is determined depending on the embedding from the first set and the embedding provided independently of the character string. This means that an embedding of the first set without a corresponding embedding in the second set is taken into account.

Preferably, according to an example embodiment of the present invention, for a first embedding from the first set for which the second set does not comprise a corresponding embedding, a second embedding from the first set for which the second set comprises a corresponding embedding is determined, and one of the variables for predicting the fact is determined depending on the first embedding and the second embedding and the embedding from the second set that corresponds to the second embedding. This means that an embedding of the first set without a corresponding embedding in the second set is taken into account together with an embedding from the first set for which a corresponding embedding in the second set exists.

Preferably, according to an example embodiment of the present invention, the variable for predicting the fact depending on the first embedding and the second embedding and the embedding corresponding to the second embedding is determined depending on an average of the first embedding and the second embedding. As a result, the two embeddings are taken into account together.

Preferably, according to an example embodiment of the present invention, mutually corresponding embeddings are determined depending on their position in an order of the parts of the character strings. As a result, parts that correspond to one another in the order of the division of the character string are assigned to one another.

Preferably, according to an example embodiment of the present invention, mutually corresponding embeddings are determined depending on common characters, in particular at the beginning of the relevant part of the character strings. As a result, parts that correspond to one another due to the characters in the division of the character string are assigned to one another.

Preferably, according to an example embodiment of the present invention, the character string is divided into a first list of parts, wherein the parts in the first list are uniquely assigned to the embeddings from the first set, wherein the character string is divided into a second list of parts, wherein the parts in the second list are uniquely assigned to the embeddings from the second set, wherein mutually corresponding parts in the lists are defined depending on an order in which the parts are arranged in the lists, and wherein the corresponding embeddings are determined depending on the mutually corresponding parts in the lists.

Preferably, according to an example embodiment of the present invention, the first set of embeddings is determined depending on a first vocabulary, wherein the second set of embeddings is determined depending on a second vocabulary different from the first vocabulary. The first vocabulary and the second vocabulary are different embedding vocabularies that arrive at different embeddings.

Preferably, according to an example embodiment of the present invention, the character string is broken down into the parts of the character string by certain characters of the character string and/or rules for word division and/or syllable division and/or letter division.

Preferably, according to an example embodiment of the present invention, mutually corresponding embeddings from the sets are concatenated, added, or multiplied to determine the variable.

According to an example embodiment of the present invention, the device for machine learning of facts in particular for populating a knowledge base comprises at least one processor and at least one memory, wherein the at least one processor is designed to execute instructions that, when executed on the at least one processor, cause the method of the present invention to run, and wherein the at least one memory is designed to store the instructions.

According to an example embodiment of the present invention, a program for machine learning of facts in particular for populating a knowledge base comprises instructions that, when executed on at least one processor, cause the method of the present invention to run.

Further advantageous embodiments of the present invention can be found in the following description and the figures.

### BRIEF DESCRIPTION OF THE DRAWINGS

FIG. 1 shows a schematic representation of a device for machine learning, according to an example embodiment of the present invention.

FIG. 2 shows an architecture of a part of a model for predicting facts, according to an example embodiment of the present invention.

FIG. 3 shows steps in a method for machine learning, according to an example embodiment of the present invention.

### DETAILED DESCRIPTION OF EXAMPLE EMBODIMENTS

FIG. 1 schematically shows a schematic representation of a device 100 for machine learning.

The device 100 comprises at least one processor 102 and at least one memory 104.

The at least one processor 102 is designed to execute instructions that, when executed on the at least one processor 102, cause a method for machine learning to run.

The at least one memory 104 is designed to store the instructions.

A program for machine learning of facts comprises the instructions. The at least one processor 102 is designed to execute the program.

The at least one memory 104 is, for example, designed to store a knowledge base, for example a knowledge graph.

The knowledge base comprises facts. A fact is, for example, represented by a subject, an object, and a predicate, wherein the predicate characterizes a relationship between the subject and the object.

The fact can represent knowledge about different data types, e.g., text data, image data, or audio data. The fact can for semantic segmentation,

The knowledge base comprises, for example, more than 100, more than 1,000, more than 10,000, or more than 100,000 facts.

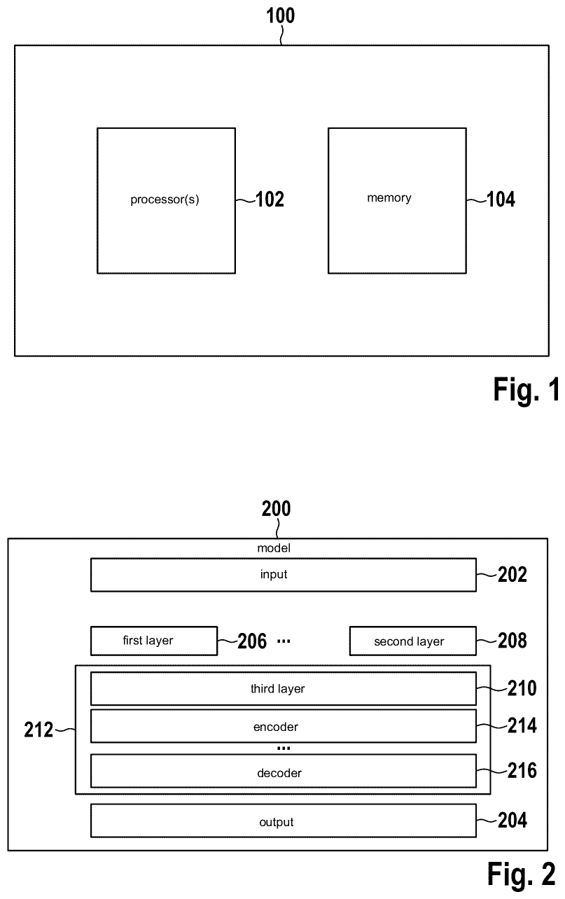

FIG. 2 schematically shows an architecture of a part of a model 200 for predicting facts.

The model 200 comprises an input 202 for a character string and an output 204 for a fact. The model 200 is designed to determine the fact depending on the character string.

For example, the character string comprises characters representing a subject and an object, where the fact comprises the subject, the object, and a predicate predicted by the model 200 for the subject and the object.

Between the input 202 and the output 204, the model 200 comprises a first layer 206, which is designed to determine embeddings of parts of the character string depending on the character string and on a first vocabulary. Between the input 202 and the output 204, the model 200 comprises a second layer 208, which is designed to determine embeddings of parts of the character string depending on the character string and on a second vocabulary. The first vocabulary and the second vocabulary in the example are embedding vocabularies that are different from one another.

The first layer 206 uses the character string as an input variable. The first layer 206 maps the character string to the embeddings of the parts of the character string.

The second layer 208 uses the character string as an input variable. The second layer 208 maps the character string to the embeddings of the parts of the character string.

For example, the first layer 206 maps the character string “acetaminophen” to embeddings of the parts “ace”, “tami”, and “nophen”. For example, the second layer 208 maps the character string “acetaminophen” to the parts “acetami” and “nophen”.

The first layer 206 in the example is a first embedding layer E1. The second layer 208 in the example is a second embedding layer E2. For n vocabularies, n layers, i.e., n embedding layers E1, E2, . . . , En can be provided. The divisions generated by the embedding layers E1, E2, . . . , En can differ from one another.

The character string is divided into its parts on the basis of the embedding of the parts. The division does not require the character string itself to be divided into its parts.

Between the first layer 206 and the second layer 208, the model 200 comprises a third layer 210, which is designed to combine mutually corresponding embeddings from the first layer 206 and from the second layer 208 to form variables for predicting the fact.

It may be provided that more than two layers, e.g., the n layers, are provided for determining embeddings of different vocabularies. It may be provided that the mutually corresponding embeddings from these layers are combined to form the variable for predicting.

Between the first layer 206 and the output 204 and between the second layer 208 and the output 204, the model 200 comprises a function 212 for predicting the fact depending on the variables.

The function 212 comprises, for example, an encoder 214 designed to map the variables to encoded variables and a decoder 216 designed to map the encoded variables to the fact at the output 204.

The function 212 is, for example, implemented as a transformer model, a recurrent recursive network (RRN), a long short-term memory (LSTM), or another neural network. The third layer 210 in the example represents a first layer of the function 212.

In the transformer model, for example, this means that meta-embeddings are created in the first layer of the transformer model. The transformer model can therefore handle two or more different vocabularies. As a result, additional domain- or language-specific embeddings to are integrated.

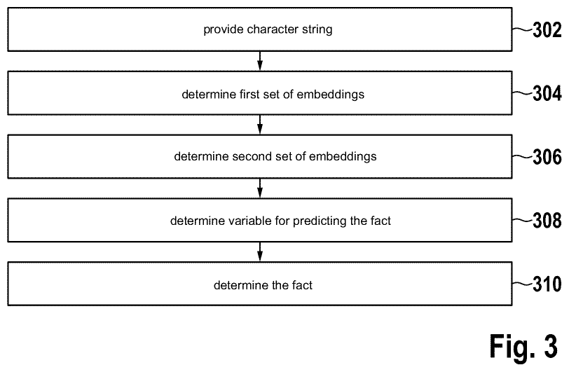

FIG. 3 shows steps in a method for machine learning.

The method is performed for machine learning of facts. In the example, a knowledge base is populated with the facts.

In a step 302, the character string is provided.

For example, the word “acetaminophen” is provided.

In a step 304, a first set of embeddings of parts of the character string is determined.

The first set of embeddings is, for example, determined depending on a first vocabulary.

In the example, the character string is divided into a first list of parts. The parts in the first list are uniquely assigned to the embeddings from the first set.

For example, the first vocabulary is used to determine the embeddings for “ace”, for “tami”, and for “nophen”.

In a step 306, a second set of embeddings of parts of the character string is determined.

The second set of embeddings is, for example, determined depending on a second vocabulary different from the first vocabulary.

For example, the second vocabulary is used to determine the embeddings for “acetami” and for “nophen”.

In the example, the character string is divided into a second list of parts. The parts in the second list are uniquely assigned to the embeddings from the second set.

It may be provided that more than two sets of embeddings are determined. The sets are, for example, determined depending on vocabularies that differ from one another. It may be provided that the character string is divided into a list of parts for each set. The parts in the relevant list are uniquely assigned to the embeddings of the set that is assigned to the relevant list.

In a step 308, a variable for predicting the fact is in each case determined for mutually corresponding embeddings from the sets.

Mutually corresponding embeddings from the sets are, for example, concatenated, added, or multiplied to determine the variable.

Mutually corresponding embeddings are, for example, determined depending on their position in an order of the parts of the character strings.

For example, due to the order, “ace” and “acetami” are determined to be first in the order and therefore corresponding.

Mutually corresponding embeddings are, for example, determined depending on a common character, in particular at the beginning of the relevant part of the character strings.

For example, due to the matching character string “ace” in the parts from the beginning of the word, “ace” and “acetami” are determined to be corresponding.

It may be provided that the variables are determined independently of an embedding from the first set for which the second set does not comprise a corresponding embedding.

For example, the embedding for “tami” from the first set is not used.

It may be provided that the variables are determined independently of an embedding from the second set for which the first set does not comprise a corresponding embedding.

It may be provided that, for an embedding from a set for which at least one other set does not comprise a corresponding embedding, an embedding is provided independently of the character string.

For example, the embedding for “tami” from the first set is used, and a corresponding embedding is specified for it.

It may be provided that, for an embedding from a set for which at least one other set does not comprise a corresponding embedding, an embedding is provided independently of the character string, for each set that does not comprise a corresponding embedding.

It may be provided that one of the variables for predicting the fact is determined depending on the embedding from the set for which at least one other set does not comprise a corresponding embedding, and depending on at least one embedding provided independently of the character string.

It may be provided that, for a first embedding from the first set for which the second set does not comprise a corresponding embedding, a second embedding from the first set for which the second set comprises a corresponding embedding is determined.

It may be provided that one of the variables for predicting the fact is determined depending on the first embedding and the second embedding and the embedding from the second set that corresponds to the second embedding.

The variable for predicting the fact is, for example, determined depending on an average of the first embedding and the second embedding and depending on the embedding corresponding to the second embedding.

It may be provided that mutually corresponding parts in the lists are defined depending on an order in which the parts are arranged in the lists.

The corresponding embeddings are, for example, determined depending on the mutually corresponding parts in the lists.

In a step 310, the fact is determined depending on the variables for predicting the fact.

In the example, the fact is stored in the knowledge base. The knowledge base is a knowledge graph, for example.

The fact relates, for example, to information that is extracted from the character string.

For example, the fact comprises a subject, an object, and a predicate, which defines a relation between subject and object.

In the example, a subject is an entity in the knowledge base that denotes a drug, e.g., acetaminophen. In the example, an object is an entity in the knowledge base that denotes a group, e.g., non-opioid analgesics. The character string comprises, for example, the subject, in the example acetaminophen, The method is, for example, used to determine an affiliation of the subject with a group of drugs. The relation is, for example, the affiliation of the subject with the group specified in the object of the fact. The information that is extracted from the character string is, for example, the object, in the example non-opioid analgesics.

The fact can also relate to a different classification, i.e., a different assignment, of the character string.

The fact can relate to the populating of the knowledge base or, for example, one of the following areas of application of natural language processing (NLP):
Machine translation of the character string,
Information extraction from the character string,
Response to the character string in particular in a dialog system,
Video analysis or audio analysis based on a classification or regression of the character string,
Time series analysis based on a classification or regression of the character string,
Anomaly detection based on a classification or regression of the character string.

The variables represent meta-embeddings, which replace a first layer of a transformer model in the example. The determination of the variables can be applied to other tasks that can be addressed with transformer models. This relates to the listed NLP tasks, further NLP tasks, and also non-NLP tasks.

A transformer model consists, for example, of an embedding layer followed by several encoder layers and/or decoder layers. The meta-embeddings replace the embeddings of this first embedding layer of the transformer model with the meta-embeddings.

Alternatively, the meta-embeddings can also be used with other model architectures and embedding methods in order to connect them in general at a finer granularity than words.

1-13. (canceled)

14. A computer-implemented method for machine learning of a fact for populating a knowledge base, the method comprising the following steps:
providing a character string;
determining a first set of embeddings of parts of the character string;
determining a second set of embeddings of parts of the character string;
determining the fact for the knowledge base, depending on variables for predicting the fact, wherein, for mutually corresponding embeddings from the first and second sets, one variable of the variables for predicting the fact is determined in each case.

15. The method according to claim 14, wherein the variables are determined independently of an embedding from the first set for which the second set does not include a corresponding embedding.

16. The method according to claim 14, wherein, for an embedding from the first set for which the second set does not include a corresponding embedding, an embedding is provided independently of the character string, and one of the variables for predicting the fact is determined depending on the embedding from the first set and the embedding provided independently of the character string.

17. The method according to claim 14, wherein, for a first embedding from the first set for which the second set does not include a corresponding embedding, a second embedding from the first set for which the second set includes a corresponding embedding is determined, and one of the variables for predicting the fact is determined depending on the first embedding and the second embedding and the embedding from the second set that corresponds to the second embedding.

18. The method according to claim 17, wherein the variable for predicting the fact depending on the first embedding and the second embedding and the embedding corresponding to the second embedding is determined depending on an average of the first embedding and the second embedding.

19. The method according to claim 14, wherein mutually corresponding embeddings of the first and second sets are determined depending on their position in an order of the parts of the character string.

20. The method according to claim 14, wherein mutually corresponding embeddings are determined depending on common characters at a beginning of a relevant part of the character string.

21. The method according to claim 14, wherein the character string is divided into a first list of parts, wherein the parts in the first list are uniquely assigned to the embeddings from the first set, wherein the character string is divided into a second list of parts, wherein the parts in the second list are uniquely assigned to the embeddings from the second set, wherein mutually corresponding parts in the first and second lists are defined depending on an order in which the parts are arranged in the first and second lists, and wherein the corresponding embeddings are determined depending on the mutually corresponding parts in the first and second lists.

22. The method according to claim 14, wherein the first set of embeddings is determined depending on a first vocabulary, wherein the second set of embeddings is determined depending on a second vocabulary different from the first vocabulary.

23. The method according to claim 14, wherein the character string is broken down into the parts of the character string by: certain characters of the character string and/or rules for word division and/or syllable division and/or letter division.

24. The method according to claim 14, wherein mutually corresponding embeddings from the first and second sets are concatenated, or added, or multiplied, to determine the one variable.

25. A device for machine learning of facts for populating a knowledge base, the device comprising:
at least one processor; and
at least one memory, wherein the at least one processor is configured to execute instructions machine learning of a fact for populating a knowledge base, the instructions, when executed by the at least one processor, cause the at least one processor to perform the following steps:
providing a character string,
determining a first set of embeddings of parts of the character string,
determining a second set of embeddings of parts of the character string,
determining the fact for the knowledge base, depending on variables for predicting the fact, wherein, for mutually corresponding embeddings from the first and second sets, one variable of the variables for predicting the fact is determined in each case;
wherein the at least one memory is configured to store the instructions.

26. A non-transitory machine-reachable medium on which stored a program for machine learning of facts for populating a knowledge base, the program including instructions which, when executed by at least one processor, cause the at least one processor to perform the following steps
providing a character string;
determining a first set of embeddings of parts of the character string;
determining a second set of embeddings of parts of the character string; and
determining the fact for the knowledge base, depending on variables for predicting the fact, wherein, for mutually corresponding embeddings from the first and second sets, one variable of the variables for predicting the fact is determined in each case.
